(19) United States
(12) Patent Application Publication
(10) Pub. No.: US 2021/0112783 A1
(43) Pub. Date: Apr. 22, 2021

(54) Bird Feeder Cover Lifting Device

(71) Applicant: Frank W Dicorte, Waco, TX (US)

(72) Inventor: Frank W Dicorte, Waco, TX (US)

(21) Appl. No.: 17/069,713

(22) Filed: Oct. 13, 2020

Related U.S. Application Data
(60) Provisional application No. 62/916,051, filed on Oct. 16, 2019.

(51) Int. Cl. A01K 39/012; F16M 13/02

(52) U.S. Cl. CPC A01K 39/0125; F16M 13/02

(57) ABSTRACT

A lifting device for the manual lifting of bird feeder covers and holding them in a temporary position above the main body of the bird feeder device while the bird feeder is refilled or cleaned manually.

### PRIORITY CLAIM

This application claims priority to U.S. Provisional Application No. 62/916,051 filed on Oct. 16, 2019, which is hereby incorporated by reference.

### TECHNICAL FIELD OF THE INVENTION

The present invention is generally directed to a device that can be used to lift and hold the cover of a bird feeder in order to allow access to the internal portion of the bird feeder for filling it with bird seed or for cleaning purposes.

### BACKGROUND OF THE INVENTION

With regard to bird feeders, and particularly with regard to bird feeders designed to prevent squirrels or other small, climbing animals from eating bird seed out of the bird feeders, the bird feeders are typically equipped with covers (sometimes also called “domes”) that sit on top of a main feed hopper and serve to prevent bird seed contained within the hoppers from becoming wet during wet weather events and also, ideally, prevent squirrels or other small, climbing animals from accessing the hoppers and eating the bird seed contained therein. One such bird feeder that is designed to be squirrel-resistant is disclosed in U.S. Pat. No. 5,791,286 to Taussig, et. al., which was later assigned to Arundale Products, Inc. (referred to as the “Arundale Feeder”).

The Arundale Feeder features a main hopper for holding bird seed that sits on top of a bottom tray that has a central conic surface that protrudes upwardly at the center of the bottom tray. The central conic surface of the tray is a somewhat raised conic surface at the center of the tray that allows the birdseed contained within the hopper to continuously feed downwards and outwards through bottom edge gaps at the base of the hopper due to gravity and/or agitation and then onto the outer edges of the tray where the seeds can be eaten by birds. The Arundale Feeder also features a unique squirrel proof conic cover comprised of an angled conic skirt, a sharply angled central cone and a closing conic section at its top in which an aperture is disposed that allows for the cover to be slid upwards or downwards in relation to a chain, rope or cord from which the Arundale Feeder may be suspended in air. The intent of placing the aperture in the closing conic section of the conic cover is obviously to allow for the cover to be moved upwards in order to fill the hopper with seed or to clean the inside of the hopper, while at the same time being able to take these actions without the necessity of taking the Arundale Feeder down and without disconnecting the Arundale Feeder from the chain, rope, or cord by which it is suspended.

A variety of different types of washers may also optionally be placed above the closing conic section at the top of the cover of the Arundale Feeder when it is suspended using a chain, cord or rope. When used, such washer (or washers) have the purpose of further limiting access of precipitation or other substances or insects from entering the main hopper through the areas of the aperture in the closing conic section that are not completely occupied by the chain, cord, or rope from which the feeder is suspended. In a typical embodiment of the Arundale Feeder, one rubber washer and one metal washer are placed above the closing conic section of the top cover such that the chain, cord, or rope passes through the aperture of the closing conic section and also through the two washers, and when the feeder is closed the two washers are brought into snug contact with the top edge of the closing conic section.

Although the inventors of the Arundale Feeder undoubtedly intended for the feeder's hopper to be easy to refill with bird seed and to clean while remaining suspended in air, in actual practice refilling the hopper with bird seed or cleaning the inside of the hopper when the feeder remains suspended above the ground is not a very easy task to accomplish for many people. The obvious reason for this is that the feeder's cover tends to simply fall back down onto the top of the hopper by force of gravity after it has been initially lifted upwards and out of the way, and therefore it requires at least one hand (or one arm if the cover is tucked under one arm) in order to hold the bird feeder cover up while refilling or cleaning the hopper with the other hand/arm. Thus, a person attempting to manually refill or clean the Arundale Feeder without taking it down from the position where it is suspended, will have to use one of their hands to hold the cover upwards and out of the way in order to gain access to the hopper, while attempting to use the other hand to either hold a bag of seed and pour some of that seed into the hopper or hold a cleaning implement and clean the inside of the hopper. If a person is using a scoop to place the bird seed into the hopper, this can be even more complicated. Added to this, these types of refilling or cleaning operations are often being done while the person engaged in such activities is standing on a ladder, and the use of both hands in the simultaneous operations of holding the top cover and refilling or cleaning the hopper will not leave another hand to hold the ladder, which could cause the ladder or the person using the ladder to become unsteady and fall, thereby resulting in injury. The difficulty of these manual operations is compounded even further by the fact that if the feeder remains suspended, the hopper, tray, and other parts of the feeder may swing around freely and from side to side on the chain, cord, or rope because there is not a third hand to hold them steady in place during refilling or cleaning.

Therefore, what is needed is a device to hold the covers of suspended bird feeders up and out of the way when the bird feeders are being either refilled with bird seed or cleaned manually. What is also needed is a device that can be used to assist in moving any washers associated with the bird feeders back down to the level of the top of the covers of the bird feeders after refilling or cleaning of the hopper has occurred. Both of these needs are true not just with regard to the Arundale Feeder, but are also true of other similar squirrel-resistant bird feeders, including those that feature a top conic cover above the main bird seed hopper wherein the conical design of the covers are used to prevent or hinder squirrels and other climbing animals from accessing the hopper.

### SUMMARY OF THE INVENTION

It is an object of the present invention to provide a device that can be used to hold the top cover of a suspended bird feeder up and out of the way while a person is manually refilling the feeder's hopper with seed or is manually cleaning the inside of the hopper. It is a further object of the present invention to provide a device that can be used to move any washers suspended above the top cover of a bird feeder back downward to abutment with the top edge of the top cover of the bird feeder after refilling or cleaning of a suspended bird feeder has been completed.

The present invention accomplishes the above-described objects. The present invention is a bird feeder cover lifting device (sometimes simply referred to as a “cover lifter” or “cover lifting device”) that has an elongate main body with a top end and a bottom end. In a preferred embodiment of the cover lifter, at the top end of the device two sides of the elongate main body taper upwardly at a first taper angle to two tines of a forked nose piece, then the two tines themselves are each also upwardly tapered at a second taper angle to two top tine points. As a result of the first taper angle, the distance between the main bodies of the two tines is less than the width of the majority of the main body of the elongate lifter. As a result of the second taper angle, the distance between the top tine points of the two tines is less than the distance between the bases of the two tines. Together, the two tines of the forked nose piece at the top of the device cooperate to form a chain channel that terminates in a through hole that is disposed within a washer-receiving cup that is itself a recessed area disposed within the elongate body of the cover lifter. In the preferred embodiment, the cover lifter will feature a contoured handle near its bottom end where the elongate main body may be gripped and held firmly for placement or use of the device. In the preferred embodiment of the device, the bottom end of the device that is below the handle will feature a multiplicity of angled fins whose bottom points define a conic receiver base.

As can be best understood with reference to the accompanying drawings and the detailed description below, the bird feeder cover lifting device hereby disclosed may be inserted into a bird feeder and placed in position such that it holds the cover of the bird feeder up and out of the way while a person is using their hands for actions like pouring bird seed into the bird feeder's hopper or holding onto a ladder on which they are standing. In order to use the cover lifter, the forked nose piece at the top of the cover lifter is inserted into the conical bodies of a conical shaped bird feeder cover and used to push the whole conical cover upwards, following which the bottom part of the cover lifter may be placed into the main body of the feeder's hopper and placed upright on top of the tray below the hopper. In the case where the bird feeder tray features a centered, raised conic surface, the conic receiver base of the cover lifter that is formed by cooperation of the multiplicity of angled fins will cause the cover lifter to stand upright and in-place, and the cover lifter will thereby hold the conic cover up and above the top lip of the feeder's hopper. In a preferred embodiment, the total height of the cover lifting device when so placed within the bird feeder in an upright/standing position will be at least twice as tall as the bird feeder's hopper as measured from the level of the feeder's tray at the bottom of the feeder. Further description is provided below with reference to the accompanying drawings.

### BRIEF DESCRIPTION OF THE DRAWINGS

FIG. 1 is a side view of a bird feeder that is extremely similar to the Arundale Feeder discussed above, but which also shows two washers above the closing conic section.

FIG. 2 is a top view of the bird feeder cover lifting device.

FIG. 3 is a side view of the bird feeder cover lifting device featuring a section view of the top of the device taken along the A-A line.

FIG. 4 is an up-close, detailed section view of the top of the device taken along the A-A line.

FIG. 5 is a side view of the bird feeder with a top view of the cover lifter during use showing the cover lifter being used to hold the feeder open.

FIG. 6 is a detail side view of the top of the cover lifter when it is in use holding a bird feeder open.

FIG. 7 is a detail side view of the bottom of the cover lifter during use holding a bird feeder open.

FIG. 8 is a perspective view of the cover lifter device when it is in use pulling washers back down toward the top of the bird feeder cover.

FIG. 9 is a perspective view of the bird cover lifting device being used to initially push the cover of the feeder upwards.

### DETAILED DESCRIPTION OF THE PREFERRED EMBODIMENTS

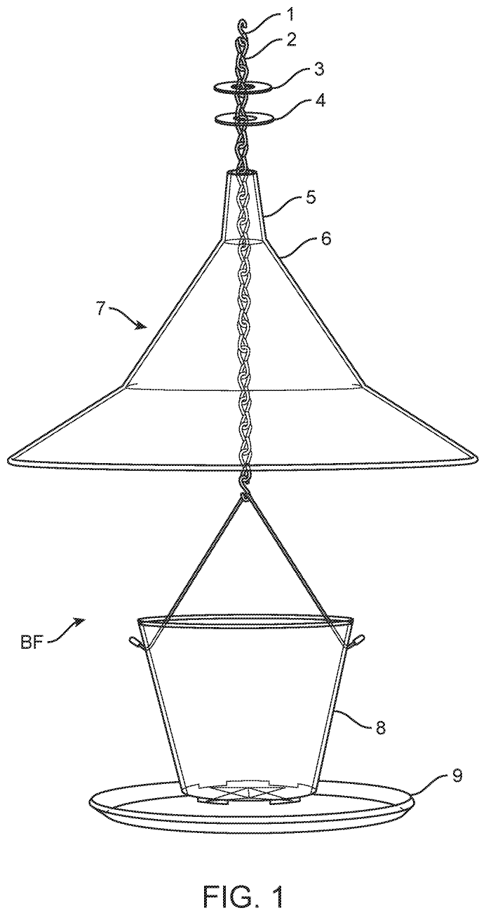

FIG. 1 illustrates a squirrel resistant bird feeder BF of a category of feeders that feature a conical-shaped cover 7, a hopper 8, and a bottom tray 9. The cover 7 is comprised of a closing conic section 5 and an angled central cone 6. The bird feeder BF may be suspended from a chain 2 that is held at its top end to some other structure above (not illustrated) by a hook 1. There may also be a rubber washer 4 and a metal washer 3 that are placed above the closing conic section 5 and are capable of sliding movement up and down along the chain 2. The bird feeder BF is not part of the invention hereby disclosed and claimed, but it may be viewed as a workpiece of the invention. The bird feeder BF illustrated in FIG. 1 is intended to be representative of multiple different types of bird feeder devices that are in the squirrel resistant bird feeder category due to their conically-shaped top covers, for most of which the bird cover lifting device that is hereby disclosed can be used to lift the top cover up and hold it in place above the rest of the bird feeder to provide access to the hopper for refilling or cleaning.

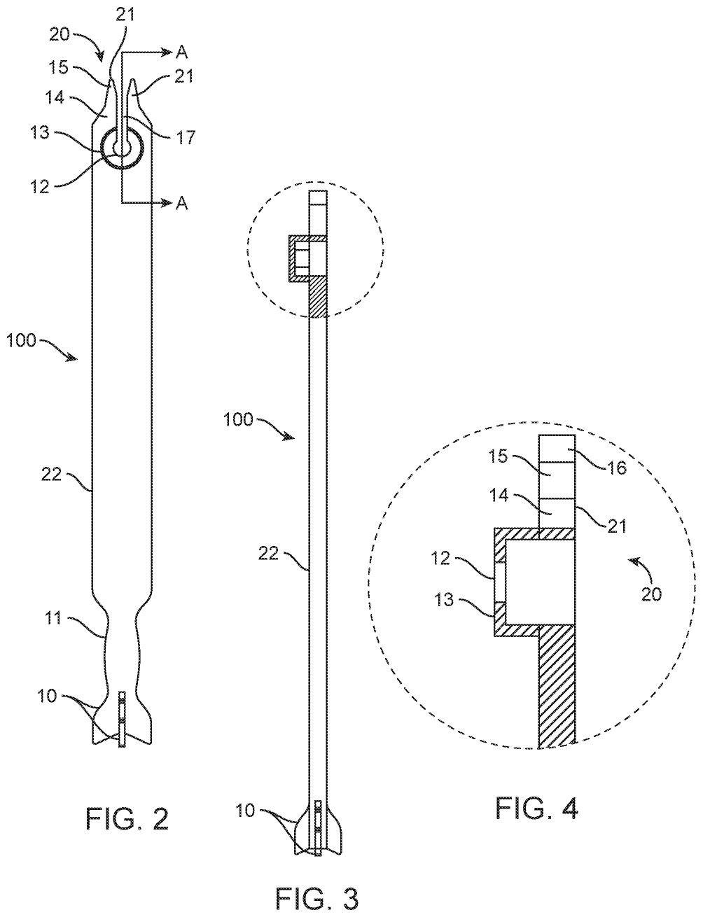

FIG. 2 shows the preferred embodiment of the bird feeder cover lifting device 100. As shown in FIG. 2, the bird feed cover lifting device 100 features an elongate body 22 with a forked nose piece 20 at its top and a multiplicity of fins 10 at its bottom. The cover lifting device 100 also features a contoured handle 11 for gripping by a user. The forked nose piece 20 is comprised of two tines 21. The elongate body 22 is upwardly tapered on each of its sides at a first taper angle 14 and then a second taper angle 15, with the taper angles 14, 15 helping to define the tines 21 of the forked nose piece 20. The two tines 21 of the forked nose piece 20 cooperate to define a chain channel 17 that terminates at a through-hole 12 that passes through the center of a washer-receiving cup 13, which is best described as a recessed area or an indented cupped area within the cover lifting device 100. The multiplicity of angled fins 10 at the bottom of the cover lifting device cooperate to form a recessed area for potential receiving of a raised conical surface if such a raised conical surface is present at the center of the bottom tray of a bird feeder in which the device 100 is inserted.

FIG. 3 is a side view of the same bird feeder cover lifting device 100 showing a dashed-line circle around the top of the device 100 for which a detailed, up-close section view will be provided in FIG. 4. In turn, FIG. 4 provides a detailed, up-close section view taken along the A-A line for the top of the device 100. FIG. 4 is intended to further illustrate the features of one of the ines 21 showing its top tip 16 and attempting to illustrate the approximate position of the first taper angle 14 and second taper angle 15 in relation to the washer-receiving cup 13 and the through-hole 12.

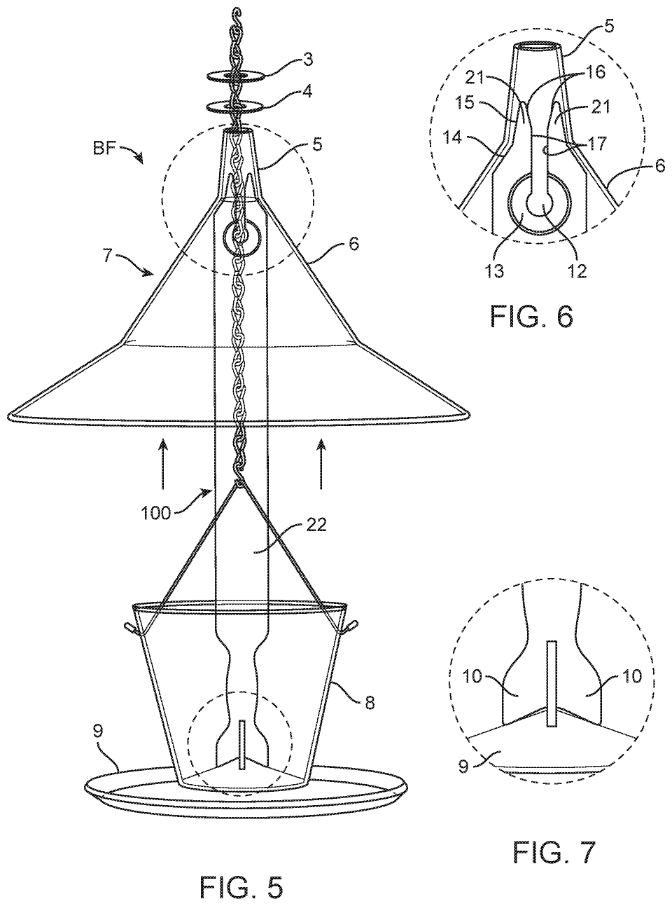

FIG. 5 shows a side view of the bird feeder BF and a top view of the bird feeder cover lifting device 100 while the latter is in-use holding the bird feeder BF open. As illustrated, when the device 100 is in use, it is standing upright within the bird feeder BF and holding the cover 7 up above, and separated from, the hopper 8 and tray 9 below. As can be understood, this allows for the hopper 8 to be more conveniently refilled with new bird seed or cleaned. When such refilling or cleaning is done, the device 100 can simply be removed from the inside of the bird feeder BF. FIG. 6 illustrates how the base of the tines 21 defined by the first tapered angles 14 can be inserted into and brought into abutment with the internal angled surface of the angled central cone 6 while the second tapered angles 15 and the top tine points 16 can be inserted into and potentially brought into abutment with the internal angled surface of the closing conic section 5 of the bird feeder BF in order to lift and hold the cover 7 upward and above the hopper 8 and the tray 9. FIG. 6 also again illustrates the presence of the chain channel 17 and the presence of the through-hole 12 in the washer-receiving cup 13. FIG. 7 illustrates how the multiplicity of fins 10 may be brought into cupping abutment with a raised conical surface at the center of the tray 9 when the device 100 is in-use in an upright position within the bird feeder BF holding it open for refilling or cleaning.

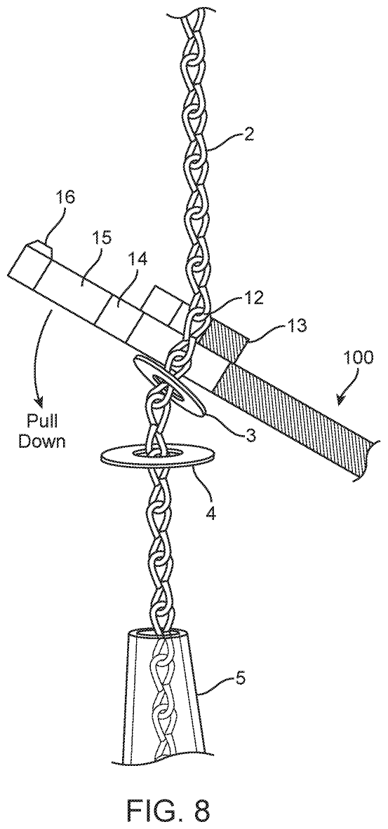

FIG. 8 shows the cover lifting device 100 after it has been removed from the bird feeder BF following completion of refilling or cleaning of the hopper 8. In FIG. 8, the device 100 is now being used to move the two washers 3, 4 downwardly along the length of the chain 2 so that they will be brought into abutment with, and will cover, the top of the closing conic section 5. This is sometimes necessary because such washers will frequently become stuck on the chain, cord, or rope above the top cover after the cover has been replaced on top of the hopper. In FIG. 8, the main functionality of the chain channel 17, through-hole 12, and washer-receiving cup 13 are more readily appreciated. As can be seen, when the device 100 is used to push or pull the washers 3, 4 downward toward the top of the closing conic section 5, the chain 2 can be passed through the chain channel 17 until it is within the through-hole 12, and as the device 100 is thereafter moved downward, the washers 3, 4 are cupped within the washer-receiving cup 13 so that they can be more firmly held as they are pushed or pulled down the length of the chain toward the top of the closing conic section 5. The chain channel 17 and through-hole 12 may also be used when the device 100 is initially placed within the bird feeder BF and is used to move the cover 7 upwards because the chain 2 may sometimes pass through the chain channel 17 and the through-hole 12 during that operation, but alternatively they may not always be necessary for that purpose when the cover 7 is being moved upward and later held in place above the hopper 8.

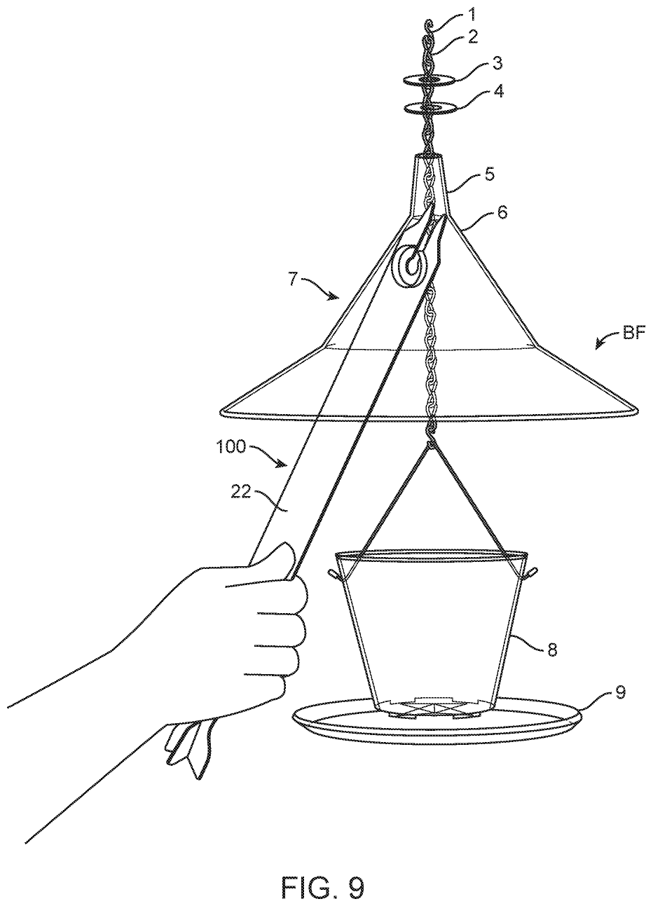

FIG. 9 is simply meant to illustrate the bird feeder cover lifting device 100 when it is being used to manually lift the cover 7 of a bird feeder BF upwardly and out of the way of the hopper 8 so as to open the bird feeder BF and allow ready access to the hopper 8 for refilling it with seed or cleaning it using some type of handheld cleaning implement.

As discussed above, in a preferred embodiment, the total length of the bird cover lifting device 100 will be at least twice as long as the height of a bird feeder's hopper. This should allow enough space for the hopper to be conveniently and efficiently filled with bird seed when the device 100 is in-use and is standing upright within the bird feeder holding a top cover above, and separate from, the hopper below.

It should also be noted that that in embodiments featuring angled fins at the bottom of the cover lifting device, there should be at least three, and preferably four, angled fins at the bottom of the cover lifting device. Three fins will provide the ability to maintain the device in an upright standing position when it is in-use in a manner similar to a three-legged stool. Three fins will also provide a recessed section for receiving a raised conical surface in situations where the tray of a bird feeder features a raised conical surface at its center, such as with the previously mentioned Arundale Feeder. However, four angled fins at the bottom of the device are preferable since they will provide enhanced stability, an enhanced receiving/cupping effect for a raised conical surface, and will arguably be more aesthetically pleasing. Regardless of whether three or four fins are used, the fins will also hold the device upright in situations where the top surface of the tray is flat rather than featuring a raised conical surface.

Moreover, the inventor also envisions that the top end of the device could merely be tapered on its sides so that it terminates in a single top point that could be inserted into the conical cover of a squirrel resistant bird feeder to lift that cover up and hold it above the hopper. The forked nose piece comprised of two tines with a channel disposed between the two tines has been described above because it is a preferred embodiment of the invention, but the invention nonetheless also includes a cover lifter that is tapered on its sides to a single point at its top end such that the single point could be used with a conical bird feeder cover in much the same way as the two tine points 16 described above. Further, and in addition, the multiplicity of angled fins at the bottom of the device that are used as means of standing the device upright on the tray while the device is in use could be replaced with a round downwardly-facing cup or downwardly-facing bowl structure that would hold the device upright and could also cuppingly engage any raised conical surface at the center of the tray below, and this proposed embodiment would not depart from the invention that is hereby disclosed.

The bird cover lifting device hereby disclosed is primarily envisioned as a useful accessory to squirrel resistant bird feeders of the type illustrated in the drawings that have conically-shaped top covers and may feature bottom trays with raised conical surfaces, which would obviously include, but is not limited to, the Arundale Feeder that was disclosed in U.S. Pat. No. 5,791,286. And while the device hereby disclosed is therefore not intended solely for use with the Arundale Feeder and no such narrow limitation should be read into this application or into the invention that is hereby disclosed, the inventor has found that the cover lifter device hereby disclosed is ideally suited for use as an accessory to the Arundale Feeder.

The embodiments and other features, aspects, and advantages of the present invention may be best understood and appreciated with reference to the drawings, descriptions, and claims. Where used in the various figures of the drawings, the same numerals designate the same or similar parts. Furthermore, when the terms“top”, “bottom”, “front”, “back”, “distal”, “proximal”, “lateral”, “vertical”, “horizontal”, “central”, “first”, “second”, “third”, “inside”, “internal”, “outside”, “external”, “end”, “ends”, “side”, “sides”, “edge”, “edges” and similar terms are used herein, it should be understood that, unless otherwise specifically stated or otherwise made specifically clear by context, these terms have reference only to the structure shown in the drawings as it would appear to a person viewing the drawings, and such terms are utilized solely in order to facilitate describing the invention and in order to facilitate a better understanding of the invention.

Although the invention has been described with reference to specific embodiments, this description is not meant to be construed in a limiting sense. Various modifications of the disclosed embodiments, as well as alternative embodiments of the invention, will be apparent to persons skilled in the art upon reference to the description of the invention. It is, therefore, contemplated that the appended claims will cover such modifications that fall within the scope of the invention.

I claim:

1. A bird feeder cover lifting device comprised of:
An elongate body with a top end and a bottom end, wherein the top end is tapered at an angle to a top point and wherein the bottom end provides a stand featuring a recess area defined by the stand.

2. The device of claim 1, wherein the top end of the device is defined by tapered angles on two sides of the device, and where the tapered angles end in the top point.

3. The device of claim 1, wherein the stand is comprised of three downwardly angled fins.

4. The device of claim 3, wherein the stand is comprised of a fourth downwardly angled fin.

5. The device of claim 1, wherein the stand is comprised of a downwardly opening cup.

6. A bird feeder cover lifting device comprised of:
an elongate body with a distal end and a proximal end, wherein the distal end of the elongate body is forked and features two tines, each of which ends in a tine point;
wherein the distance between the two tine points is less than the width of the main portion of the elongate body from one side to the other side of the elongate body;
and wherein the proximal end of the device provides a stand.

7. The device of claim 6, wherein the elongate body of the device is tapered at an angle on at least two sides and such tapers culminate in the two tine points.

8. The device of claim 7, wherein the stand is comprised of three downwardly angled fins.

9. The device of claim 8, wherein the stand is comprised of a fourth downwardly angled fin.

10. The device of claim 7, wherein the stand is comprised of a downwardly opening cup.

11. The device of claim 6, wherein two sides of the main body of the device are each tapered at a first upwardly angled taper and a second upwardly angled taper, with the second upwardly angled taper of each side culminating at a tine point of the forked distal end.

12. The device of claim 11, wherein the first upwardly angled taper corresponds with the angle of the internal surface of the sharply angled central cone of the bird feeder taught in U.S. Pat. No. 5,791,286, and the second upwardly angled taper corresponds with the angle of the internal surface of the conic closure apex of the bird feeder taught in U.S. Pat. No. 5,791,286.

13. The device of claim 12, further featuring a channel disposed between the two tines at the distal end of the device.

14. The device of claim 13, further featuring a defined through-hole that is at the bottom of the aforesaid channel.

15. The device of claim 14, wherein there is a washer-receiving cup provided by the device, and the aforementioned through hole is an aperture that passes through the center of the washer-receiving cup.

16. The device of claim 15, wherein the stand is comprised of three downwardly angled fins.

17. The device of claim 16, wherein the stand is comprised of a fourth downwardly angled fin.

18. The device of claim 17 further featuring a handle located next to the proximal end of the elongate body and immediately above the location of the multiplicity of angled fins.

19. The device of claim 4 further featuring a handle located next to the proximal end of the elongate body and immediately above the location of the multiplicity of angled fins.
